(19) United States
(12) Patent Application Publication
(10) Pub. No.: US 2024/0040673 A1
(43) Pub. Date: Feb. 1, 2024

(54) HEATED GLASS COVER FOR OPTICAL SENSOR

(71) Applicant: AGC GLASS EUROPE, Louvain-la-Neuve (BE)

(72) Inventors: Xavier GOFFINET, Gosselies (BE); Xavier LALOYAUX, Gosselies (BE); Jean MASSON, Gosselies (BE); Yannick SARTENAER, Vedrin (BE)

(73) Assignee: AGC GLASS EUROPE, Louvain-la-Neuve (BE)

(21) Appl. No.: 18/256,610

(22) PCT Filed: Dec. 9, 2021
(86) PCT No.: PCT/EP2021/085067

§ 371 Date: Jun. 8, 2023

(30) Foreign Application Priority Data
Dec. 16, 2020 (EP) 20214501.7

(51) Int. Cl. H05B 3/84; H05B 3/12; H05B 3/16

(52) U.S. Cl. CPC H05B 3/84; H05B 3/12; H05B 3/16; H05B 2203/003; H05B 2203/017; G01S 7/4811

(57) ABSTRACT

A glass cover for an optical sensor comprising a heating system. The heating system comprises a pattern of wires having a width between 14 and 300 μm, preferably between 25 and 200 μm, more preferably between 35 and 100 μm, even more preferably between 45 and 55 μm. A related sensor device that includes the glass cover as well as a method to obtain the glass cover are also disclosed.

### FIELD OF THE INVENTION

The present invention relates to the field of glass cover for optical sensor. The present invention also relates to a sensor device comprising such glass cover. The present invention also relates to a method to obtain such glass cover.

### BACKGROUND OF THE INVENTION

Nowadays vehicles comprise an increasing number of devices and systems to assist and even to replace the driver. A vehicle includes cars, vans, lorries, motorbikes, buses, trams, trains, airplanes, helicopters, drones and the like. The trend is moving towards fully autonomous vehicles able to manage various situations by themselves. Various optical sensors are therefore needed in order for the vehicle to assess the situation encountered, such as cameras, radars and lidars. These optical sensors usually comprise a cover to protect the detection system. This cover is transparent to the operating wavelength of the optical sensor. It can be made of glass, plastics or a combination thereof.

It is of tremendous importance the cover of such optical sensor being kept free of mist and frost. Otherwise the vehicle is blind to its environment. The vehicle must therefore wait until the cover is defogged and/or defrosted in order to be able to drive securely. There exist many ways to defog/defrost such cover.

EP3355661 mentions a self-regulating heater to defog/defrost the windshield in the area of an onboard camera. CN110703535 discloses a heating element heating the air comprised between the camera and the glass by heat radiation. However, the heating power produced by thermal convection via hot air remains limited. The defrosting time is therefore not compatible with new requirements of defogging/defrosting. By the way, such equipment has a rather large footprint while the trend is to have as small equipment as possible.

JP2018020771 mentions heating wires included in a conductive film in a windshield. The heating wires have a diameter ranging between 5 and 200 μm. The heating wires are positioned out of the field of view (FOV) of the camera as they would disturb the acquisition by the camera. CN208862951 mentions a silk-printed antifog glass with a silver paste layer formed on the outer circumference of the glass covering a camera. The silk-print is also formed out of the FOV of the camera. Such kind of heating elements placed out of the FOV of the optical device are too slow to defog/defrost the centre of the FOV in a reasonable time. One solution could be to increase the power in order to defog/defrost the centre of the FOV, but it therefore creates hotspots. Moreover it is also needed to carefully adjust the position of the camera and of the cover (the cover meaning both a part of the windshield or the cover of the camera itself) in order for the heating elements (wires or silver paste layer) not to stand in the FOV of the camera.

WO2019107460 mentions a windshield made of two glass plates and including an intermediate film. The intermediate film, usually made of PVB, includes a heat generation layer comprising heating wires not larger than 10 μm. The heating wires are placed in the FOV of the information acquisition device. However the embedded wire in PVB interlayer required kapton for connection to power supply. This kapton can lead to problem of sealing of the laminated glazing leading to a local delamination or the humidity penetration inside the laminated glass. Moreover the optical properties of PVB interlayer is less stable to temperature than glass. This is linked to their refractive index modification according to the temperature. For a given temperature variation during the heating, the heated PVB exhibits around 100 times more variation on path length of the light than a heated glass. During heating, that results to a large optical variation. The thermal diffusivity in the PVB is also lower than the one for the glass. That means the thermal gradient is sharp and the heated PVB inhibits a homogeneous heating. The thermal stability of the PVB is also a problem. Since the power density is high for optical sensor and the thermal diffusivity is low, the local temperature of the PVB in contact with the embedded wires could reach a value higher than 150° C. which can be critical for interlayer durability. Finally the connection of very thin embedded wires in the interlayer to a busbar can be very difficult and therefore leads to poor connection. That leads to hot spot formation at the connection area between the busbar and the thin embedded wires and a decrease of the defrosting performance. Due to its thickness, the busbar also creates optical distortion on the final laminated in the area of positioning which is generally not far from the FOV.

There is therefore a need for an easy-to-install system to rapidly heat a cover of an optical sensor with no or very low disturbance on the signal perceived by the optical sensor.

### SUMMARY OF THE INVENTION

The present invention concerns a glass cover for an optical sensor comprising a heating system. The heating system comprises a pattern of wires made of a conductive material positioned in the field of view of the optical sensor on the glass cover. The heating system also comprises at least two electronic pads positioned out of the field of view of the optical sensor on the glass cover configured to connect the pattern to a power supply. The wires have a width comprised between 14 and 300 μm, preferably between 25 and 200 μm, more preferably between 35 and 100 μm, even more preferably between 45 and 55 μm.

The present invention also relates to a sensor device comprising such glass cover.

The present invention also relates to a method to obtain such glass cover.

### BRIEF DESCRIPTION OF THE DRAWINGS

The invention will now be described further, by way of examples, with reference to the accompanying drawings, wherein like reference numerals refer to like elements in the various figures. These examples are provided by way of illustration and not of limitation. The drawings are a schematic representation and not true to scale. The drawings do not restrict the invention in any way. More advantages will be explained with examples.

FIG. 1a illustrates a series pattern of mainly vertical wires according to the present invention.

FIG. 1b illustrates a parallel pattern of mainly vertical wires according to the present invention.

FIG. 2a illustrates a series pattern of mainly horizontal wires according to the present invention.

FIG. 2b illustrates a parallel pattern of mainly horizontal wires according to the present invention.

FIG. 3a illustrates a series pattern of mainly oblique wires according to the present invention.

FIG. 3b illustrates a parallel pattern of mainly oblique wires according to the present invention.

### DETAILED DESCRIPTION OF ILLUSTRATIVE EMBODIMENTS

The present invention will be described with respect to particular embodiments and with reference to certain drawings but the invention is not limited thereto but only by the claims.

While some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

The present invention proposes a glass cover for an optical sensor. The glass cover is understood as the cover of the optical sensor itself. The glass cover can also be part of a bigger glass plate positioned in front of the optical sensor, such as a part of a windshield behind which the optical sensor is placed. As mentioned, the glass cover is made of (mineral) glass, more specifically a silica-based glass, such as soda-lime-silica, alumino-silicate or boro-silicate type glass. The glass cover can also be made of an association of glass and plastics.

The optical sensor can be a camera or a lidar. Optical sensor is understood as a sensor able to receive wavelength from the visible range (400 to 750 nm) and/or from the near infrared range (750 to 1650 nm). It could also apply to a sensor able to receive wavelength from the ultraviolet range.

The glass cover comprises a heating system. The heating system comprises a pattern of wires. The wires are made of a conductive material. The wires are positioned on the glass cover. The wires are usually positioned on the face of the glass cover which faces the optical sensor. However the wires can also be positioned on the opposite face of the glass cover. The wires are positioned in the field of view (FOV) of the optical sensor. The wires can also exceed the FOV of the optical sensor as the wires are not strictly restrained to the FOV of the optical sensor.

The conductive material may refer to a conductive ink or to a conductive paste. Conductive ink may refer, for example, to a silver ink for screen printing, for which a super fine silver powder is dispersed uniformly into a polyester resin in order to create a silver ink, with a solid content usually between 70% and 85%. Conductive ink may also refer to a carbon ink for ink printing, with a solid content usually between 35% and 40%. Conductive ink may also refer to a silver paste for screen printing with a silver content ranging between 55% and 85%. Conductive ink may also refer to a silver ink for inkjet, with 30% to 40% of metal loading. Conductive ink may also refer to a silver ink for aerosol jet, with a silver content around 50%. These are only examples of current conductive ink and conductive paste and do not restrain the realization of the present invention with another type of conductive ink or conductive paste.

The heating system also comprises at least two electronic pads to connect the pattern to a power supply. These pads are positioned on the glass cover, out of the FOV of the optical sensor.

The wires have a width comprised between 14 and 300 μm, preferably between 25 and 200 μm, more preferably between 35 and 100 μm, even more preferably between 45 and 55 μm. A width of 50 μm is optimal. The wires are deposited on the glass in order to use the high thermal diffusivity of the glass. The wires are thin enough to limit, even to avoid the disturbance of the optical sensors.

In a preferred embodiment, the pitch of the pattern is comprised between 4 and 20 mm, preferably between 5 and 15 mm, more preferably between 6 and 10 mm, even more preferably between 7 and 8 mm. The pitch is understood as the distance between two wires. The pitch is crucial for the homogeneous heating. A large pitch provokes a high thermal gradient. A low pitch increases the number of wires in the FOV. The pitch is a compromise between the homogeneous heating and the wire density in the FOV.

In a preferred embodiment, the glass cover can be a portion of a windshield, a sidelite or a backlite of a vehicle or a portion of a trim element of a vehicle. An interior trim element of a vehicle is defined as glass or plastic molding, frames, and other decorative additions to vehicle bodies and interiors. An exterior trim element includes bumpers, window/door seals, wheel wells, and headlights. Manufacturers use these to add aesthetics, increase function, and add flexibility to the vehicle design.

In a preferred embodiment, the wires are deposited on the glass cover by silk screen, digital printing or aerosol printing.

In a preferred embodiment, the conductive material is composed of particles of a diameter lower than 5 μm. In another preferred embodiment, the conductive material is composed of nanoparticles. In a preferred embodiment, those particles or nanoparticles are made of silver. The thin conductive wire can be done with a dark conductive ink, for example carbon, in order to decrease, or even to avoid the beam reflection in contact with the conductive wire.

In a preferred embodiment, the pattern is mainly constituted by horizontal or vertical or oblique wires.

In a preferred embodiment, the optical sensor is a lidar. As a lidar is a particularly sensitive optical sensor, putting a pattern of wires on the FOV of the lidar usually perturbs the signal, and the measure is disturbed. However thin wires as proposed in the present invention have been found not to perturb significantly the signal emitted and/or received by the lidar.

In a preferred embodiment, the wires are protected by a coating like a polymeric resin or a magnetron coating to improve the durability. In case of a polymeric resin, it can be applied on the wires only. In case of a magnetron coating, it is applied on the whole cover.

The present invention also proposes a sensor device. The sensor device comprises a housing and a sensor. The sensor device also comprises a glass cover as described previously.

In a preferred embodiment, the sensor device comprises a sensor being a lidar. The present invention also proposes a method to obtain a glass cover. The method comprises the steps of providing a glass. Then a pattern of wires (2) made of a conductive material is printed on the glass, by silk screen, digital printing or aerosol printing. Then at least two electronic pads (3) are placed on the glass in order to connect the pattern of wires (2) to a power supply.

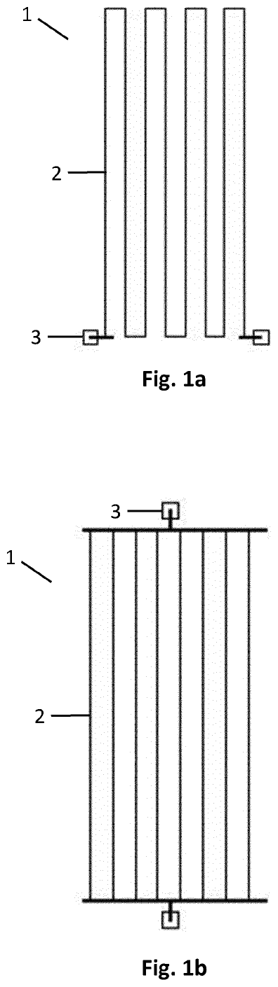

Referring to FIG. 1a, the heating system (1) of the glass cover (not shown) comprises a pattern of wires (2). In this embodiment, the wires (2) are essentially vertical. The wires (2) are positioned on the glass cover (not shown), in the FOV of the optical sensor (not shown).

The pattern of wires (2) is connected to two electronics pads (3). These electronic pads are positioned out of the FOV of the optical sensor (not shown). These two pads (3) allow to furnish electricity to the pattern of wires (2). In this embodiment, the pattern of wires (2) is connected in series.

Referring to FIG. 1b, the heating system (1) of the glass cover (not shown) comprises a pattern of wires (2). In this embodiment, the wires (2) are essentially vertical. The wires (2) are positioned on the glass cover (not shown), in the FOV of the optical sensor (not shown).

The pattern of wires (2) is connected to two electronics pads (3). These electronic pads are positioned out of the FOV of the optical sensor (not shown). These two pads (3) allow to furnish electricity to the pattern of wires (2). In this embodiment, the pattern of wires (2) is connected in parallel. The connection in parallel has the additional advantage that if one of the wires (2) is damaged the other wires (2) can still be powered.

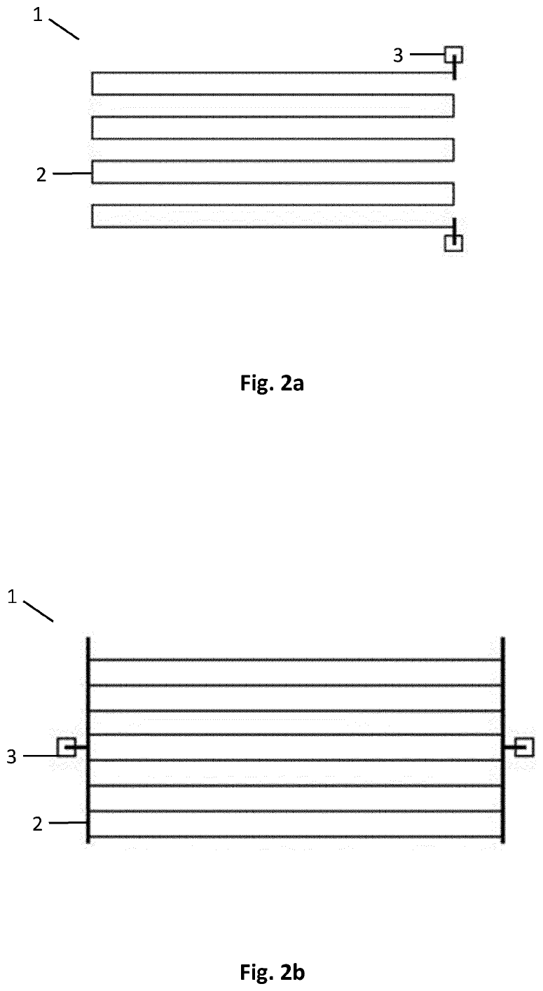

Referring to FIG. 2a, the heating system (1) of the glass cover (not shown) comprises a pattern of wires (2). In this embodiment, the wires (2) are essentially horizontal. The wires (2) are positioned on the glass cover (not shown), in the FOV of the optical sensor (not shown).

The pattern of wires (2) is connected to two electronics pads (3). These electronic pads are positioned out of the FOV of the optical sensor (not shown). These two pads (3) allow to furnish electricity to the pattern of wires (2). In this embodiment, the pattern of wires (2) is connected in series.

Referring to FIG. 1b, the heating system (1) of the glass cover (not shown) comprises a pattern of wires (2). In this embodiment, the wires (2) are essentially horizontal. The wires (2) are positioned on the glass cover (not shown), in the FOV of the optical sensor (not shown).

The pattern of wires (2) is connected to two electronics pads (3). These electronic pads are positioned out of the FOV of the optical sensor (not shown). These two pads (3) allow to furnish electricity to the pattern of wires (2). In this embodiment, the pattern of wires (2) is connected in parallel. The connection in parallel has the additional advantage that if one of the wires (2) is damaged the other wires (2) can still be powered.

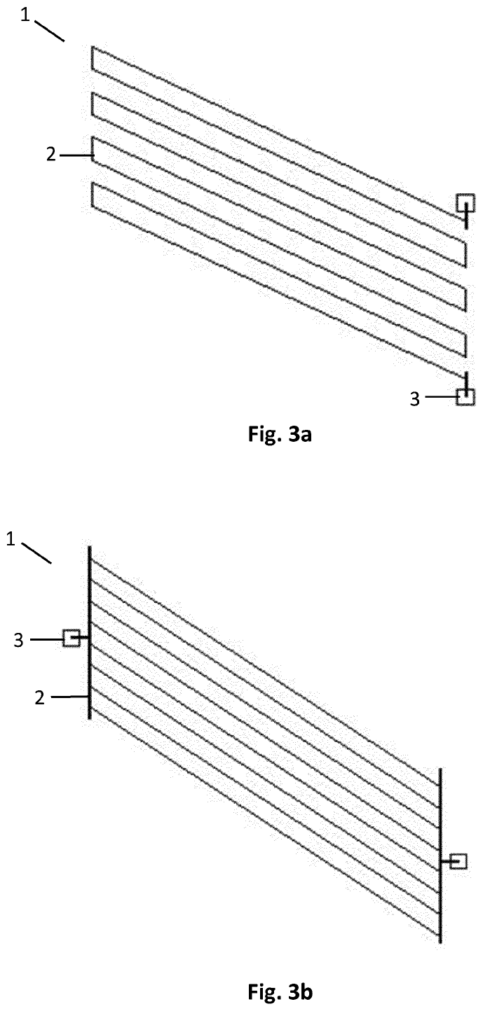

Referring to FIG. 3a, the heating system (1) of the glass cover (not shown) comprises a pattern of wires (2). In this embodiment, the wires (2) are essentially oblique. The wires (2) are positioned on the glass cover (not shown), in the FOV of the optical sensor (not shown).

The pattern of wires (2) is connected to two electronics pads (3). These electronic pads are positioned out of the FOV of the optical sensor (not shown). These two pads (3) allow to furnish electricity to the pattern of wires (2). In this embodiment, the pattern of wires (2) is connected in series.

Referring to FIG. 3b, the heating system (1) of the glass cover (not shown) comprises a pattern of wires (2). In this embodiment, the wires (2) are essentially oblique. The wires (2) are positioned on the glass cover (not shown), in the FOV of the optical sensor (not shown).

The pattern of wires (2) is connected to two electronics pads (3). These electronic pads are positioned out of the FOV of the optical sensor (not shown). These two pads (3) allow to furnish electricity to the pattern of wires (2). In this embodiment, the pattern of wires (2) is connected in parallel. The connection in parallel has the additional advantage that if one of the wires (2) is damaged the other wires (2) can still be powered.

While the invention has been illustrated and described in detail in the drawings and foregoing description, such illustration and description are to be considered illustrative or exemplary and not restrictive. The foregoing description details certain embodiments of the invention. It will be appreciated, however, that no matter how detailed the foregoing appears in text, the invention may be practiced in many ways. The invention is not limited to the disclosed embodiments.

1. A glass cover for an optical sensor comprising a heating system comprising:
a. a pattern of wires made of a conductive material positioned in a field of view of the optical sensor on the glass cover;
b. at least two electronic pads positioned out of the field of view of the optical sensor on the glass cover configured to connect the pattern of wires to a power supply;
wherein the wires have a width comprised between 14 and 300 μm.

2. The glass cover according to claim 1, wherein the conductive material is a conductive ink or a conductive paste.

3. The glass cover according to claim 1, wherein a pitch of the pattern of wires is between 4 and 20 mm.

4. The glass cover according to claim 1, wherein the glass cover is a portion of a windshield, a sidelite or a backlite of a vehicle or a portion of a trim element of a vehicle.

5. The glass cover according to claim 1, wherein the wires are deposited on the glass cover by silk screen, digital printing or aerosol printing.

6. The glass cover according to claim 1, wherein the conductive material is composed of particles of a diameter lower than 5 μm.

7. The glass cover according to claim 1, wherein the conductive material is composed of nanoparticles.

8. The glass cover according to claim 6, wherein the particles or nanoparticles are made of silver.

9. The glass cover according to claim 1, wherein the pattern of wires is mainly constituted by horizontal or vertical or oblique wires.

10. The glass cover according to claim 1, wherein the optical sensor is a lidar.

11. The glass cover according to claim 1, wherein the wires are coated with a polymeric resin.

12. The glass cover according to claim 1, wherein the glass cover is coated with a magnetron coating.

13. A sensor device comprising a housing, a glass cover according to claim 1.

14. The sensor device according to claim 13, wherein the sensor is a lidar.

15. A method to obtain the glass cover according to claim 1 comprising:
providing a glass;
printing the pattern of wires made of the conductive material on the glass, by silk screen, digital printing or aerosol printing; and
connecting the pattern of wires to a power supply through at least two electronic pads positioned on the glass.

16. The glass cover according to claim 1, wherein the wires have a width between 25 and 200 μm.

17. The glass cover according to claim 1, wherein the wires have a width between 35 and 100 μm.

18. The glass cover according to claim 1, wherein the wires have a width between 45 and 55 nm.

19. The glass cover according to claim 3, wherein the pitch of the pattern of wires is between 5 and 15 mm.

20. The glass cover according to claim 3, wherein the pitch of the pattern of wires is between 6 and 10 mm.
